(19) United States
(12) Patent Application Publication
(10) Pub. No.: US 2026/0118113 A1
(43) Pub. Date: Apr. 30, 2026

(54) SHAPE MEASURING DEVICE AND COMPUTER-READABLE MEMORY MEDIUM

(71) Applicant: Fanuc Corporation, Minamitsuru-gun, Yamanashi (JP)

(72) Inventors: Takuma OOKURA, Minamitsuru-gun, Yamanashi (JP); Tooru KUBOTA, Minamitsuru-gun, Yamanashi (JP); Hideki KUROKI, Minamitsuru-gun, Yamanashi (JP)

(73) Assignee: Fanuc Corporation, Minamitsuru-gun, Yamanashi (JP)

(21) Appl. No.: 19/120,517

(22) PCT Filed: Oct. 27, 2022
(86) PCT No.: PCT/JP2022/040245

§ 371 Date: Apr. 11, 2025

(51) Int. Cl. G01B 11/26; G01B 11/00; G01B 11/06

(52) U.S. Cl. CPC G01B 11/26; G01B 11/005; G01B 11/0608

(57) ABSTRACT

This shape measuring device: obtains the height of a surface of a measurement object from a distance sensor that moves relative to the surface of the measurement object; calculates coordinate values of a rising portion or falling portion present at the surface of the measurement object; stores reference values for the coordinate values of the rising portion or falling portion; compares said reference values with coordinate values calculated by a coordinate value calculation unit; determines coordinate values different from the reference values as being invalid data; changes speed conditions for the relative speed between the measurement object and the distance sensor; and determines a factor of the invalid data by making comparisons with coordinate values calculated according to different speed conditions.

### CROSS REFERENCE TO RELATED APPLICATION

This is the U.S. National Phase application of PCT/JP2022/040245, filed Oct. 27, 2022, the disclosure of this application being incorporated herein by reference in its entirety for all purposes.

### FIELD OF THE INVENTION

This disclosure relates generally to a shape measuring device and a computer-readable memory medium.

### BACKGROUND OF THE INVENTION

There are conventional shape measuring devices that irradiate a measurement object with measurement light to measure a position of each part of the measurement object. For example, Patent Literature 1 discloses such a device.

### PATENT LITERATURE

[Patent Literature 1] Japanese Patent Laid-Open Publication No. 2014-137265

### BRIEF DESCRIPTION OF THE DRAWINGS

FIG. 1 is a block diagram of a shape measuring device;

FIG. 2 is a schematic diagram of a shape measuring device for measuring a linear measurement object;

FIG. 3 is a schematic diagram of a shape measuring device for measuring a circular measurement object;

FIG. 4 is a schematic view showing linear coordinate values;

FIG. 5 is a schematic view showing circular coordinate values;

FIG. 6 is a schematic diagram showing changes in the coordinate values;

FIG. 7 is a schematic view showing coordinate values when chattering occurs;

FIG. 8 is a schematic diagram showing changes in the coordinate values;

FIG. 9 is a flowchart illustrating an operation of the shape measuring device; and

FIG. 10 is a hardware configuration diagram of the shape measuring device.

### DETAILED DESCRIPTION OF EMBODIMENTS OF THE INVENTION

According to the disclosure, some shape measuring devices are configured to store reference values for rising and falling edges of a signal, and compare the reference values with measurement results to determine the accuracy of the shape of a measurement object. In the shape measurement, false detection may occur.

In the field of shape measuring devices, a technology to determine factors of false detection is desired.

One aspect of the present disclosure is a shape measuring device that includes: a coordinate value calculation unit that acquires a height of a surface of a measurement object from a distance sensor that moves relative to the surface of the measurement object, and calculates coordinate values of a rising edge or falling edge existing on the surface of the measurement object based on the height; a reference value storage unit that stores reference values of the coordinate values of the rising edge or falling edge; a data comparison unit that compares the reference values with coordinate values calculated by the coordinate value calculation unit; and a factor determination unit that determines coordinate values that are different from the reference values as incorrect data, changes a speed condition of a relative seed between the measurement object and the distance sensor, and makes a comparison of coordinate values calculated on a different speed condition to thereby determine a factor causing the incorrect data.

### First Embodiment

A description will now be made about a shape measuring device 100 according to a first embodiment. The shape measuring device 100 is applied to a machine, such as a gear measuring instrument, for measuring uneven portions of a measurement object. The shape measuring device 100 may be applied to a controller, such as numerical controller, for other devices, and an information processing device, such as personal computer (PC). The constituent elements of the shape measuring device 100 differ depending on devices to which the measuring device 100 is applied.

The constituent elements of the shape measuring device may be categorized by their functions and need not be clearly distinguishable in their physical and programmatic configurations.

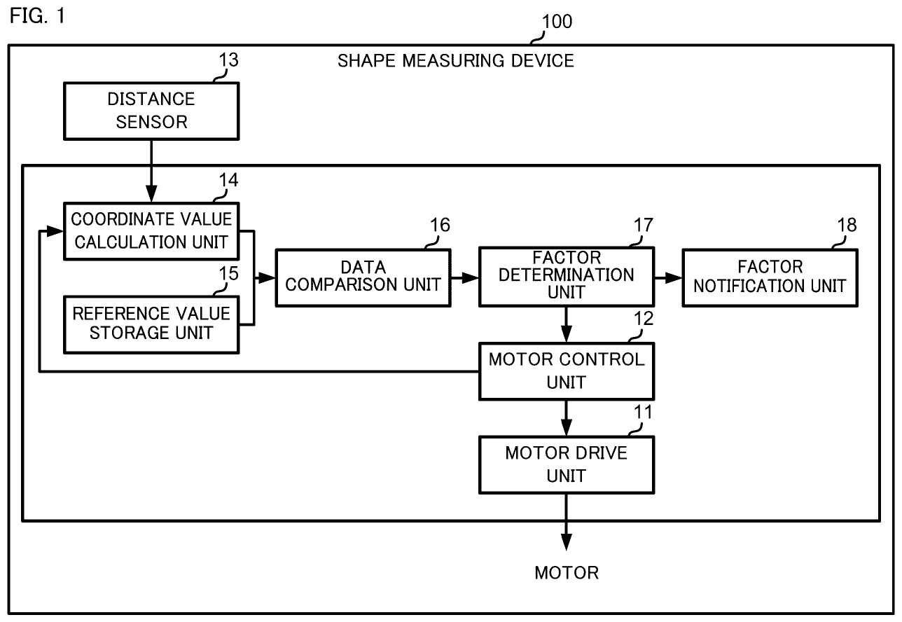

FIG. 1 is a block diagram of the shape measuring device 100. The shape measuring device 100 includes a motor drive unit 11, a motor control unit 12, a distance sensor 13, a coordinate value calculation unit 14, a reference value storage unit 15, a data comparison unit 16, a factor determination unit 17, and a factor notification unit 18.

The motor drive unit 11 is configured to drive a motor according to commands from the motor control unit 12. The motor is equipped with an encoder, not shown. The encoder outputs a rotation angle of the motor.

The motor control unit 12 is configured to acquire the rotation angle of the motor to control a rotation speed (rotation angle) of the motor. A method for controlling the motor differs between a linear measurement object (workpiece) and a circular measurement object.

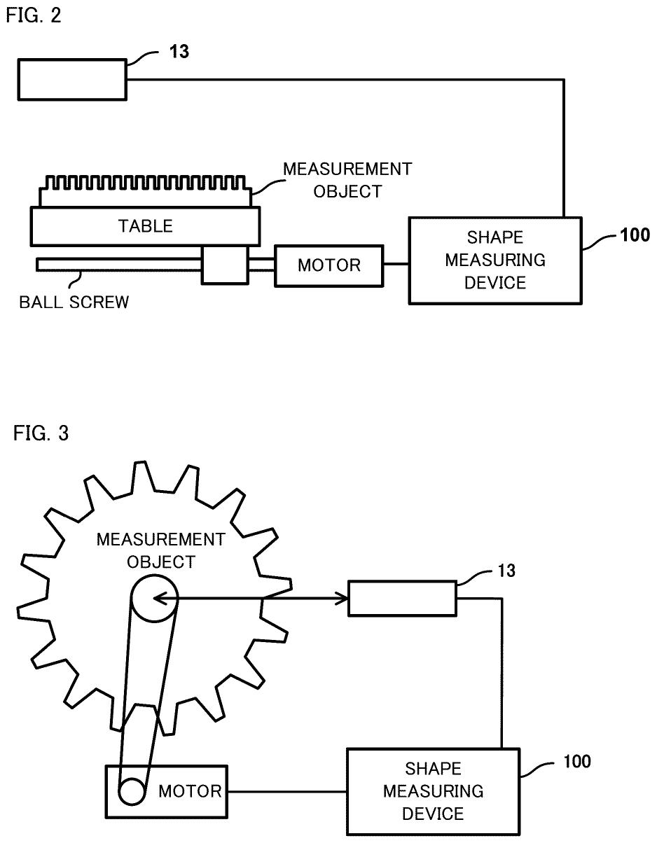

In the case of the linear measurement object, a rotation movement of the motor is converted into a linear movement by a ball screw, as shown in FIG. 2. The motor control unit 12 controls a relative position of the distance sensor 13 and the measurement object (a table on which the measurement object is mounted).

In the case of the circular measurement object, the motor rotates the circular measurement object, as shown in FIG. 3. The motor control unit 12 controls the rotation speed (rotation angle) of the motor acquired from the encoder.

The distance sensor 13 is configured to irradiates the measurement object with an acoustic wave, light and the like to detect the height of the surface of the measurement object according to reflection from the measurement object.

The coordinate value calculation unit 14 is configured to calculate coordinate values of rising edge and falling edge of unevenness on the surface of the measurement object based on the height of the surface of the measurement object detected by the distance sensor 13. The coordinate values are calculated by existing technology.

The units of the coordinate values differ between the linear measurement object and the circular measurement object.

In the case of the linear measurement object, the coordinate values are the position of the distance sensor with respect to the measurement object.

In the case of the circular measurement object, the coordinate values are the angles of the motor.

The reference value storage unit 15 is configured to store reference coordinate values. The reference coordinate values indicate the positions of the rising edge and falling edge on the surface of the measurement object. The cross-section of the linear measurement object in the illustrative embodiment has a rectangular shape for purposes of illustration, but may be a different shape, such as trapezoidal shape.

The reference values include a machine coordinate of a machine that measures the measurement object, relative coordinate to an origin set on the machine coordinate, a distance between coordinates (or angle difference), and similar.

The machine coordinate is unique to the machine. The relative coordinate has an arbitrary point on the machine coordinate as a start point. The distance between coordinates is a distance between two or more reference values on the machine coordinate.

In the case where the measurement object is circular, one point on a rotary axis is set as an origin. The relative coordinate has an arbitrary point on the rotary axis as the start point. The distance between the coordinates is a distance between two or more reference values on the rotary axis.

The reference value can be calculated from an ideal original shape of the measurement object, a blueprint of the measurement object and others. For example, the ideal original shape of the measurement object is measured, and coordinate values of the rising edge and falling edge in the original shape are used as reference values. The reference values of the rising edge and falling edge can be calculated from the blueprint. As the reference values, tolerances may be set. In a case where the tolerances are set, the factor determination unit 17 determines that coordinate values that exceed the tolerances as incorrect data.

The date comparison unit 16 is configured to compare the coordinate values of the rising edge and falling edge calculated by the coordinate value calculation unit 14 with the reference values stored in the reference value storage unit 15. In a case where the coordinate values of the rising and falling edges differ from the reference values according to the comparison result, the concerned data is determined as incorrect data.

When the data comparison unit 16 detects the incorrect data, the factor determination unit 17 sends a command to the motor control unit 12 to change a speed condition of the motor, so as to conduct remeasurement of the coordinate values.

In a case where coordinate values equal to the previous coordinate values are detected as a result of the change in the speed condition of the motor, the factor determination unit 17 determines that the factor causing the incorrect data is the faulty shape of the measurement object. In a case where coordinate values different from the previous coordinate values are detected as a result of the change in the speed condition of the motor, the factor determination unit 17 determines that the factor causing the incorrect data is chattering. In a case where no incorrect data is detected as a result of the change in the speed condition of the motor, the factor determination unit 17 determines that the factor causing the incorrect data is noise or the speed condition.

The factor notification unit 18 is configured to notify a user of the determination result made by the factor determination unit 17. The notification can be made according to an existing method.

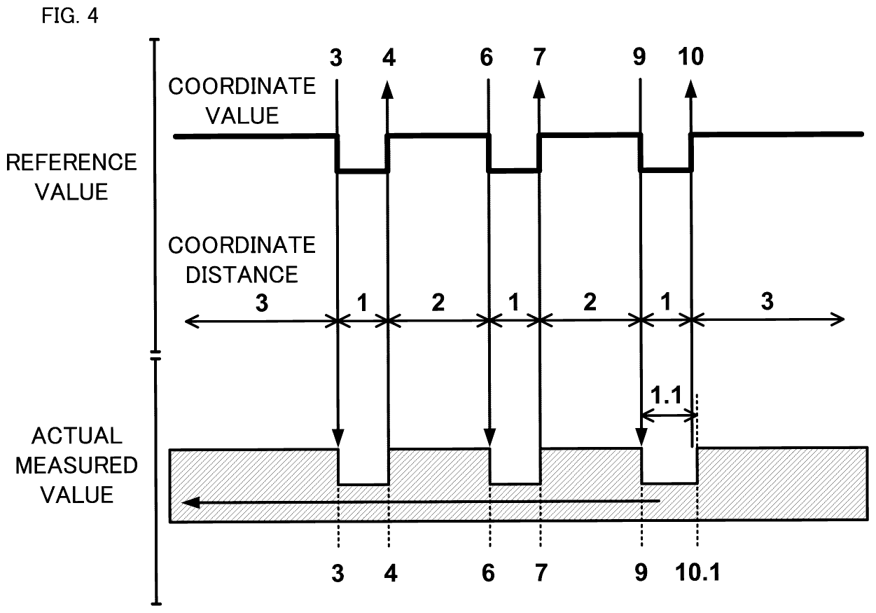

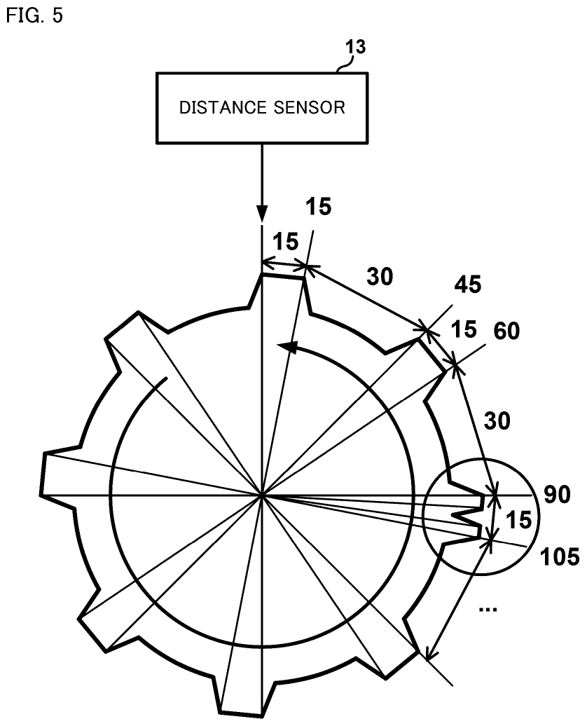

Next, the shape measuring device 100 will be described by taking a linear measurement object as an example. FIG. 4 is a schematic diagram of the shape measuring device 100 for measuring the linear measurement object. The distance sensor 13 measures the height of the surface of the measurement object while moving parallel on the measurement object.

The shape measuring device 100 detects the coordinate values of the positions of the rising edge and the falling edge on the surface of the measurement object based on the height of the surface of the measurement object detected by the distance sensor 13. The reference value storage unit 15 stores the reference values of the coordinate values of the rising edge and the falling edge. FIG. 4 draws, as reference values for the coordinate values, the coordinate values with the measurement start position of the distance sensor 13 as an origin and the reference value of the distance between the coordinates of the two points.

The reference values with the measurement start position of the distance sensor 13 as the origin are “3, 6, 9 . . . ” for the rising edge and “4, 7, 10 . . . ” for the falling edge. The reference values of the distance between the coordinates are distances “1, 2, 1, 2, 1, 3 . . . ” between the rising edge and the falling edge. The reference values of the distances between the coordinates may be a slot “all 1”.

The data comparison unit 16 compares the reference values with the coordinate values (actual measured values) detected by the distance sensor. In here, the actual measured values are “3, 4, 6, 7, 9, 10.1 . . . ”. The data comparison unit 16 determines that the coordinate value “10.1” at the third falling edge, which differs from the reference value, is incorrect data.

The factor determination unit 17 changes the speed condition of the motor when the incorrect data is detected, and starts remeasurement. The factor determination unit 17 sends a command to the motor control unit 12. On the new speed condition, the distance sensor 13 calculates coordinate values where the rising edge and falling edge occur.

The factor determination unit 17 compares the coordinate values of the rising edge and the falling edge detected on the new speed condition with the coordinate values of the rising edge and the falling edge detected on the previous speed condition. When a coordinate value in the incorrect data detected on the new speed condition differs from the coordinate value “10.1” of the incorrect data previously detected, the factor determination unit 17 determines that the factor causing the incorrect data is chattering.

When the coordinate value in the incorrect data detected on the new speed condition is the same as the coordinate value “10.1” of the incorrect data previously detected, the factor determination unit 17 determines that there is a faulty shape in the position of the coordinate value “10.1”.

In a case where the previously detected incorrect data is not detected on the new speed condition, the factor determination unit 17 determines that the factor causing the incorrect data is noise or speed condition.

Next, an example of measuring a circular measurement object will be described. FIG. 5 is a schematic diagram of the shape measuring device 100 that measures the circular measurement object. The distance sensor 13 irradiates the surface of the measurement object with laser, for instance. The measurement object is rotated to allow the laser to measure the height of the surface of the measurement object. The measurement object in FIG. 5 has a missing portion in the position at “95 degrees”.

The reference value storage unit 15 stores the reference values for the coordinate values of the rising edge and the falling edge. The schematic diagram in FIG. 5 draws, as reference values for the coordinate values, reference values that have one point on a rotary axis as an origin and a distance between coordinates of two points on the rotary axis. The reference values having one point on the rotary axis as the origin are coordinate values of the rising edge “0, 45, 90, 135 . . . ” and coordinate values of the falling edge “15, 60, 105, 150 . . . ”. The reference values of the distances between the coordinates can be expressed by, for instance, “tooth tip: 15, between-tooth: 30” or angles between the rising edge and the falling edge “15, 30, 15, 30, 15 . . . “.

For example, when the measurement object is rotated at a certain speed, the distance sensor 13 detects the coordinate values of the rising edge “0, 45, 90, 100, 135 . . . ” and the coordinate values of the falling edge “15, 60, 95, 105, 150 . . . “.

The coordinate value detected by the distance sensor 13 may be expressed by a difference in an angle between two points (tooth tip: 15, 5, between-tooth: 30, 5).

The factor determination unit 17 compares the reference values with the coordinate values detected by the distance sensor 13. The fourth coordinate value of the rising edge “100” and the third coordinate value of the falling edge “95” are different from the reference values. The factor determination unit 17 determines that the coordinate values “100” and “95”, which are different from the reference values, are incorrect data.

The factor determination unit 17 changes the speed condition of the motor in response to the detection of the incorrect data. The measurement object is then rotated at a new speed so as to be measured again on the new speed condition.

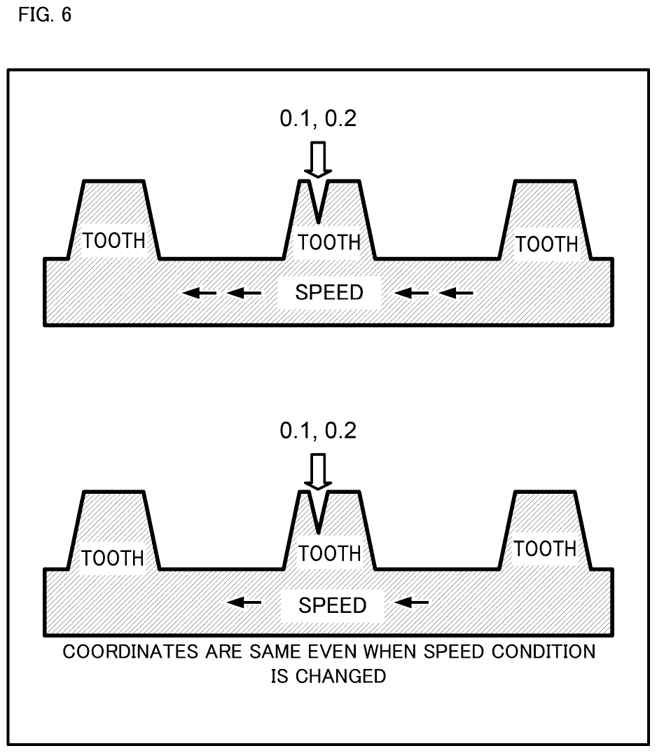

By referring to FIGS. 5 and 6, a description will be made about a process of determination that a missing portion is a factor causing the incorrect data.

The distance sensor 13 irradiates the surface of the measurement object by laser. The measurement object is rotated to allow the laser to measure the height of the surface of the measurement object. The measurement object in FIG. 5 has a missing portion in the position at “95 degrees”.

The shape measuring device 100 rotates the measurement object at a normal speed. At this time, the data comparison unit 16 compares the reference values with the coordinate values detected by the distance sensor 13, and determines that the third coordinate value “95” of the falling edge is incorrect data. The factor determination unit 17 changes the speed condition of the motor when the incorrect data is detected.

FIG. 6 is a schematic diagram showing a change in the coordinate values when the speed condition of the measurement object is changed.

In this example, the speed of the motor is reduced. In a case where the coordinate values of the incorrect data are not changed even when the speed condition of the motor is changed, the factor determination unit 17 determines that there is a missing portion in the position of the coordinate value where the incorrect data occurs.

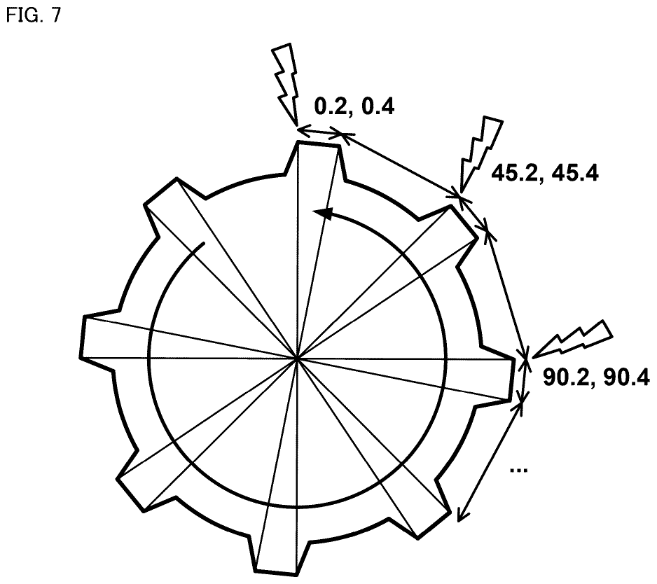

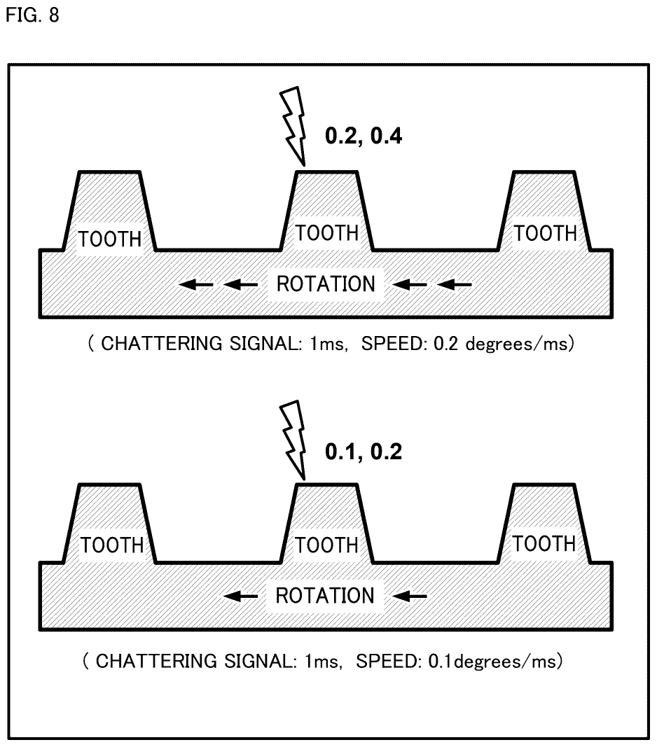

By referring to FIGS. 7 and 8, a description will be made about a process of determination that chattering is a factor causing the incorrect data.

In the shape measuring device 100 in FIG. 7, the chattering occurs in the distance sensor 13.

The distance sensor 13 irradiates the surface of the measurement object by laser. The measurement object is rotated to allow the layer to measure the height of the surface of the measurement object.

When the measurement object is rotated at a certain speed, the distance sensor 13 detects coordinate values of the rising edge “0, 0.4, 45, 45.4, 90, 90.4 . . . ” and coordinate values of the falling edge “0.2, 15, 45.2, 60, 90.2, 105 . . . “.

The distance sensor 13 may detect a difference in an angle between two points as coordinate values (tooth tip: 15, 0.2, between-tooth: 30, 0.2).

The factor determination unit 17 compares the reference values with the coordinate values detected by the distance sensor. In the example shown in FIG. 7, the coordinate value “0.4” of the second rising edge, the coordinate value “45.4” of the fourth rising edge, the coordinate value “90.4” of the sixth rising edge, the coordinate value “0.2” of the first falling edge, the coordinate value “45.2” of the third falling edge, and the coordinate value “90.2” of the fifth falling edge are different from the reference values.

The factor determination unit 17 determines these coordinate values “0.2”, “0.4”, “45.2”, “45.4”, “90.2”, and “90.4” as incorrect data.

The factor determination unit 17 changes the speed condition of the motor in response to the detection of the incorrect data. In the case of the circular measurement object, the measurement can be conducted again by changing the speed condition.

FIG. 8 shows a change in the coordinate values when the speed condition of the measurement object is changed.

Provided that the incorrect data is detected in the value of the first falling edge “0.2” and the value of the second rising edge “0.4” when the measurement object is rotated at a certain speed. The factor determination unit 17 changes the speed condition of the motor in response to the detection of the incorrect data. In this example, the speed of the motor is reduced. If the speed of the motor is 0.2 degrees/ms when a chattering signal is 1 ms, the incorrect data is generated at the coordinate values “0.2” and “0.4”. When the speed of the motor is changed into 0.1 degrees/ms, the incorrect data is generated at the coordinate values “0.1” and “0.2”.

The factor determination unit 17 changes the speed condition of the motor, and when the coordinate values of the incorrect data are changed, then determines that the chattering is the factor causing the incorrect data.

In a case where the incorrect data of the coordinate values “0.2” and “0.4” is no longer detected as a result of the change in the speed condition, the factor determination unit 17 determines that the noise or the speed condition is the factor causing the incorrect data.

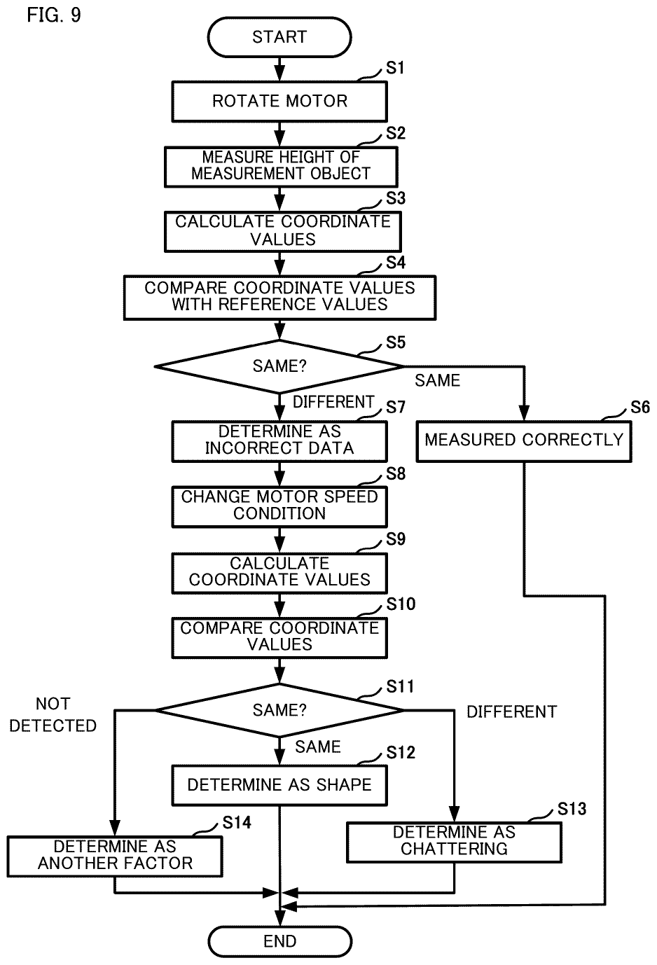

Next, an operation of the shape measuring device 100 will be described based on a flowchart of FIG. 9. The shape measuring device 100 rotates the motor at a certain speed (step S1). The rotation of the motor allows the surface of the measurement object and the distance sensor 13 to move relative to each other. The surface of the measurement object and the distance sensor 13 are moved relative to each other so that the coordinate value of the position detected by the distance sensor 13 is changed. The distance sensor 13 measures the height of the surface of the measurement object (step S2).

The shape measuring device 100 calculates the coordinate values of the rising and falling edges of the surface of the measurement object (step S3). The shape measuring device 100 compares the calculated coordinate values with the reference values (step S4).

When the detected coordinate values are the same as the reference values (step S5: same), the measurement is determined to be normal (step S6), and the factor determination process is terminated. When the coordinate values are different from the reference values (step S5: different), the shape determination device 100 determines the coordinated values detected in the step S3 as incorrect data (step S7).

When the incorrect data is detected in the step S7, the shape measuring device 100 changes the speed condition of the motor (step S8). The shape measuring device 100 changes the speed of the motor and calculates coordinate values (step S9). Then, the shape measuring device 100 compares the coordinate values of the incorrect data calculated on the new speed condition with the coordinate values of the incorrect data that is detected previously (step S10). When the coordinate values of the incorrect data detected on the new speed condition are the same as the coordinate values of the incorrect data previously detected (step S11: same), the shape measuring device 100 determines that the shape of the measurement object is the factor causing the incorrect data (step S12), and terminates the process of factor determination.

When the coordinate values of the incorrect data detected on the new speed condition are different from the coordinate values of the incorrect data previously detected (step S11: different), the shape measuring device 100 determines that the chattering is the factor causing the incorrect data (step S13).

By newly changing the speed condition, when no incorrect data is detected (step S11: not detected), the shape measuring device 100 determines that the incorrect data is caused by another factor, such as noise or speed condition.

As described above, the shape measuring device 100 of the illustrative embodiment changes the speed of the motor in response to the detection of the incorrect data that has the different values from the reference values, so as to conduct the remeasurement. In a case where the change in the speed of the motor does not cause the change in the coordinate values in the position where the incorrect data is generated, it is determined that there is a defect in the shape, such as missing portion, in the position where the incorrect data is generated.

In a case where the coordinate values are changed in the position where the incorrect date is generated, the shape measuring device 100 determines that the chattering has occurred. The chattering changes depending on the speed of the motor.

When the remeasurement result shows that the incorrect data is not generated, the shape measuring device 100 determines that another factor, such as noise or speed condition, causes the generation of the incorrect data.

According to the shape measuring device 100 of the present disclosure, since the factor causing the incorrect data can be evaluated, measurement accuracy can be enhanced. In addition to that, the factor causing the incorrect data is determined automatically, so that measurement frequency and measurement time can be reduced.

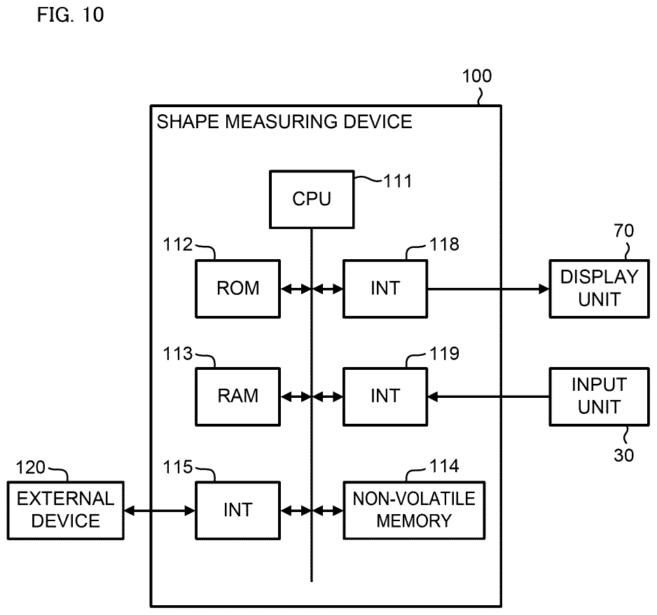

A description will now be made about a hardware configuration of the shape measuring device 100 that applies the present disclosure. FIG. 10 is a hardware configuration diagram of the shape measuring device 100. As shown in FIG. 10, the shape measuring device 100 includes a central processing unit (CPU) 111 that is configured to control the shape measuring device 100 entirely, a read-only memory (ROM) 112 that is configured to store programs and pieces of data, and a random-access memory (RAM) 113 on which the data is temporarily loaded. The CPU 111 reads a system program stored in the ROM 112 via a bus and executes a shape measurement process according to the system program.

A non-volatile memory 114 is backed up by a battery not shown, for example, so that storage conditions can be retained even when a power source of the shape measuring device 100 is turned off. The non-volatile memory 114 is configured to store programs read from an external device 120 via interfaces 115, 118 and 119 and various data about user operations and others input through an input unit 30. The non-volatile memory 114 may store programs and pieces of data for executing the shape measuring device 100 of the illustrative embodiment. Furthermore, a display unit 70 is configured to display the various data, measurement results, factors of incorrect data, and the like.

The interface 115 is configured to connect the shape measuring device 100 with the external device 120, such as an adaptor. From the external device 120, programs, various parameters and the like are read in.

The interface 118 is configured to connect the shape measuring device 100 with the display unit 70, such as a liquid crystal display. The display unit 70 displays pieces of data loaded onto the memory, and data acquired as a result of the execution of the programs, by way of example.

The interface 119 is configured to connect the shape measuring device 100 with the input unit 30, such as a keyboard or pointing device. The input unit 30 transfers commands, data and others produced based on manipulation by an operator to the CPU 111 via the interface 119.

The present disclosure has been described in detail, but is not limited to the above-described embodiments. Thus, various additions, substitutions, modifications, partial deletions and so on may be made to these embodiments without departing from the gist of the disclosure or the spirit of the disclosure as derived from the contents described in the claims and their equivalents. Furthermore, these embodiments can be implemented by combining them. For example, the order of the operations and the order of the processes in these embodiments are provided by way of example, and thus are not limited thereto.

In regard to the above-described embodiments and their variations, supplementary notes will be disclosed as below.

### (Supplementary Note 1)

A shape measuring device (100) includes a coordinate value calculation unit (14) that acquires a height of a surface of a measurement object from a distance sensor (13) that moves relative to the surface of the measurement object and calculates coordinate values of a rising edge or falling edge existing on the surface of the measurement object based on the height, a reference value storage unit (15) that stores reference values for the coordinate values of the rising edge or falling edge, a data comparison unit (16) that compares the reference values with the coordinate values calculated by the coordinate value calculation unit, and a factor determination unit (17) that determines coordinate values different from the reference values as incorrect data, changes a speed condition of a relative speed between the measurement object and the distance sensor, and makes a comparison of coordinate values calculated on a different speed condition to thereby determine a factor causing the incorrect data.

### (Supplementary Note 2)

When the coordinate values calculated on the different speed condition are the same, the factor determination unit (17) determines that the factor causing the incorrect data is the shape of the measurement object.

### (Supplementary Note 3)

When the coordinate values calculated on the different speed condition are different, the factor determination unit (17) determines that the factor causing the incorrect data is chattering in the distance sensor.

### (Supplementary Note 4)

When no incorrect data is detected as a result of changing the speed condition, the factor determination unit (17) determines that the factor causing the incorrect data is noise or the speed condition.

### (Supplementary Note 5)

The coordinate values in the shape measuring device (100) are at least one of a machine coordinate, a coordinate relative to an arbitrary reference point, and a distance between coordinates of at least two or more points.

### (Supplementary Note 6)

The reference values for the coordinate values in the shape measuring device (100) are calculated from at least one of an ideal original shape of the measurement object and a blueprint of the measurement object.

### (Supplementary Note 7)

The shape measuring device (100) includes a notification unit that notifies a user about the factor causing the incorrect data.

### (Supplementary Note 8)

A storage medium (112, 113, 114) that stores commands readable by one or more processors (111), the commands being executed by the one or more processors (111) to acquire a height of a surface of a measurement object from a distance sensor (13) that moves relative to the surface of the measurement object, calculate coordinate values of a rising edge or falling edge existing on the surface of the measurement object based on the height, compare reference values for the coordinate values of the rising edge or falling edge with the coordinate values of the rising edge or falling edge existing on the surface of the measurement object, determine that coordinate values that are different from the reference values as incorrect data, change a speed condition of a relative speed between the measurement object and the distance sensor, make a comparison of coordinate values calculated on a different speed condition to thereby determine a factor causing the incorrect data.

1. A shape measuring device, comprising:
a coordinate value calculation unit that acquires a height of a surface of a measurement object from a distance sensor that moves relative to the surface of the measurement object, and calculates coordinate values of a rising edge or falling edge existing on the surface of the measurement object based on the height;
a reference value storage unit that stores reference values of the coordinate values of the rising edge or falling edge;
a data comparison unit that compares the reference values with coordinate values calculated by the coordinate value calculation unit; and
a factor determination unit that determines coordinate values that are different from the reference values as incorrect data, changes a speed condition of a relative seed between the measurement object and the distance sensor, and makes a comparison of coordinate values calculated on a different speed condition to thereby determine a factor causing the incorrect data.

2. The shape measuring device according to claim 1, wherein when the coordinate values calculated on the different speed condition are the same, the factor determination unit determines that a factor causing the incorrect data is a shape of the measurement object.

3. The shape measuring device according to claim 1, wherein when the coordinate values calculated on the different speed condition are different, the factor determination unit determines that a factor causing the incorrect data is chattering in the distance sensor.

4. The shape measuring device according to claim 1, wherein when no incorrect data is detected as a result of changing the speed condition, the factor determination unit determines that the factor causing the incorrect data is noise or the speed condition.

5. The shape measuring device according to claim 1, wherein the coordinate values are at least one of a machine coordinate, a coordinate relative to an arbitrary reference point, and a distance between coordinates of at least two or more points.

6. The shape measuring device according to claim 1, wherein the reference values for the coordinate values are calculated from at least one of an ideal original shape of the measurement object and a blueprint of the measurement object.

7. The shape measuring device according to claim 1, comprising a notification unit that notifies a user about the factor causing the incorrect data.

8. A storage medium that stores commands readable by one or more processors, the commands being executed by the one or more processors to:
acquire a height of a surface of a measurement object from a distance sensor that moves relative to the surface of the measurement object to calculate coordinate values of a rising edge or falling edge existing on the surface of the measurement object based on the height;
compare reference values for the coordinate values of the rising edge or falling edge with the coordinate values of the rising edge or falling edge existing on the surface of the measurement object; and
determine that coordinate values that are different from the reference values as incorrect data, change a speed condition of a relative speed between the measurement object and the distance sensor, and make a comparison of coordinate values calculated on a different speed condition to thereby determine a factor causing the incorrect data.
